(19) United States
(12) Patent Application Publication
(10) Pub. No.: US 2026/0350522 A1
(43) Pub. Date: Nov. 5, 2026

(54) INDUSTRIAL PROCESS AUDIT SIMULATION

(71) Applicant: Honeywell International, Inc., Charlotte, NC (US)

(72) Inventors: ANKIT SINGH, Apex, NC (US); Eric Hartye, Oak Ridge, TN (US); Waad Subber, Schenectady, NY (US)

(21) Appl. No.: 19/194,070

(22) Filed: Apr. 30, 2025

(51) Int. Cl. G06Q 10/0639; G06Q 50/04

(52) U.S. Cl. CPC G06Q 10/06393; G06Q 50/04

(57) ABSTRACT

Techniques for simulating audits corresponding to an industrial process are described. In operation, a plurality of operational parameters corresponding to an industrial process within an industrial setup are obtained, where the plurality of operational parameters is indicative of a current operating state of the industrial process. At least one operational parameter from the plurality of operational parameters is then compared with at least one corresponding auditor threshold to identify a first deviation in the current operating state from an auditor operating protocol. A first audit finding is then generated based on the first deviation. At least a first corrective action corresponding to the first deviation is then determined based on the first audit finding. Subsequently, at least the first corrective action is recommended for mitigating the first deviation.

### BACKGROUND

In industrial setups, maintaining quality standards is fundamental for ensuring product or service excellence, operational effectiveness, and adherence to regulatory requirements. Quality standards refer to a set of criteria, specifications, guidelines, or requirements established to ensure that products, services, processes, or systems consistently meet certain levels of quality, safety, reliability, and performance. The quality standards may be defined by regulatory bodies, established by international organizations, developed internally by organizations, or created by industry associations.

### BRIEF DESCRIPTION OF DRAWINGS

FIG. 1 illustrates an environment for facilitating simulation of audits corresponding to an industrial process, in accordance with an example of the present subject matter.

FIG. 2 illustrates a schematic of a Preventive Audit Simulation System (PASS), in accordance with an example of the present subject matter.

FIG. 3 illustrates a schematic of the PASS, in accordance with another example of the present subject matter.

FIG. 4 illustrates a method for facilitating simulation of audits corresponding to the industrial process, in accordance with an example of the present subject matter.

FIG. 5 illustrates a method for obtaining a plurality of operational parameters corresponding to the industrial process, in accordance with an example of the present subject matter.

FIG. 6 illustrates a method for obtaining the plurality of operational parameters corresponding to the industrial process, in accordance with another example of the present subject matter.

FIG. 7 illustrates a method for facilitating simulation of audits corresponding to the industrial process, in accordance with another example of the present subject matter.

FIG. 8 illustrates a method for facilitating simulation of audits corresponding to the industrial process, in accordance with yet another example of the present subject matter.

FIG. 9 illustrates a method for facilitating simulation of audits corresponding to the industrial process, in accordance with yet another example of the present subject matter.

FIG. 10 illustrates a method for facilitating simulation of audits corresponding to the industrial process, in accordance with yet another example of the present subject matter.

FIG. 11 illustrates a non-transitory computer-readable medium for facilitating simulation of audits corresponding to the industrial process, in accordance with examples of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

To maintain the quality standards, various guidelines and protocols are established across different industries. Examples of such guidelines include Good Manufacturing Practices (GMP), ISO standards, Hazard Analysis and Critical Control Points (HACCP), and industry-specific regulations. For instance, in the food industry, HACCP guidelines help identify and control potential food safety hazards, while in the automotive sector, ISO/TS 16949 standards ensure consistent quality in the global automotive supply chain.

To ensure compliance with the guidelines, numerous steps may be implemented. For instance, in manufacturing environments, organizations may establish rigorous quality control processes, including in-line inspections, statistical process control, and automated defect detection systems. The organizations may also implement robust documentation practices, such as maintaining detailed batch records and standard operating procedures. In pharmaceutical industry, organizations may employ validated cleaning procedures, conduct regular equipment calibration, and maintain controlled environments to comply with GMP guidelines. Similarly, in the aerospace sector, manufacturers may implement stringent material traceability systems and conduct extensive non-destructive testing to meet industry-specific quality and safety standards. Further, organizations also invest in employee training programs to ensure that all personnel are well-versed in relevant quality standards and protocols. The organizations may further establish internal audit teams to conduct regular assessments of their processes and systems. Additionally, organizations often implement quality management software systems to streamline documentation, track compliance metrics, and facilitate continuous improvement initiatives.

To ensure adherence to the guidelines, audits are conducted. Audits are systematic evaluations that examine processes, documentation, and practices against established regulations. Audits are essential for identifying non-conformities, assessing risks, and verifying compliance with quality management systems.

When results of an audit are positive, i.e., when it is determined that an industrial setup meets the required guidelines, various certifications may be awarded to an organization corresponding to the industrial setup that significantly enhances market reputation of the organization and instils confidence in customers of the organization. For example, an ISO 9001 certification validates an organization's quality management system across industries. In the food sector, FSSC 22000 or BRC Global Standard for Food Safety certifications confirm commitment to food safety and quality. IATF 16949 certification in the automotive industry signifies compliance with specific quality standards for the automotive supply chain. AS9100 certification in the aerospace sector indicates adherence to stringent quality and safety standards for aviation, space, and defense organizations. GMP certification for pharmaceutical companies verifies compliance with Good Manufacturing Practices, crucial for regulatory compliance and market access. In the technology sector, ISO 27001 certification for information security management enhances customer trust in data protection practices. Environmental certifications like ISO 14001 demonstrate commitment to sustainable practices, appealing to environmentally conscious stakeholders.

Such certifications not only provide external validation of an organization's quality standards but also often create new business opportunities, improve competitiveness in global markets, and may be required for participation in certain tenders or supply chains. Further, such certifications offer tangible evidence of an organization's dedication to quality, safety, and continuous improvement, serving as a powerful differentiator in the competitive business landscape.

On the other hand, when the results of the audit are negative, i.e., when it is determined that the industrial setup does not meet the guidelines, there may be several consequences, such as production delays, increased scrutiny from regulatory bodies, potential fines or penalties, and damage to the organization's reputation. In severe cases, negative results may lead to suspension of operations or revocation of certifications, significantly impacting the company's ability to conduct business.

Audits are also subject to auditors'preferences with respect to the guidelines. That is, various auditors responsible for conducting audits across different industrial setups may have different preferences with respect to the guidelines and if such preferences are not met, an auditor may decide a result of the audit to be negative. The auditor preferences may be influenced by factors, such as industry experience, personal interpretation of guidelines, or specific focus areas. For instance, one auditor may place greater emphasis on documentation processes, while another may prioritize equipment maintenance procedures. Such subjectivity in audits may lead to inconsistent outcomes across different audits of an industrial setup, thereby creating challenges for organizations striving to maintain compliance.

According to examples of the present subject matter, techniques for simulating audits corresponding to an industrial process are described.

In an example of the present subject matter, a plurality of operational parameters corresponding to the industrial process within an industrial setup are obtained. The plurality of operational parameters may be indicative of a current operating state of the industrial process. Thereafter, at least one operational parameter from the plurality of operational parameters is compared with at least one corresponding auditor threshold to identify a first deviation in the current operating state from an auditor operating protocol. The at least one corresponding auditor threshold may be determined based on historical audit findings associated with at least one auditor. A first audit finding is then generated, where the first audit finding may be generated based on the first deviation.

Subsequently, at least a first corrective action corresponding to the first deviation is determined. The first corrective action may be determined based on the first audit finding. The at least first corrective action is then recommended for mitigating the first deviation.

By utilizing auditor-specific thresholds determined based on historical audit findings associated with the at least one auditor for determining deviation in the current operating state, the present subject matter accounts for individual auditor preferences with respect to various guidelines while determining the compliance of the current operating state with the auditor operating protocol. Accordingly, the present subject matter enables organizations to proactively identify potential auditor-specific compliance issues and implement relevant corrective actions before actual audits. In this manner, the present subject matter may facilitate prevention of the industrial setup from consequences associated with negative audit results, such as production delays, increased scrutiny from regulatory bodies, potential fines or penalties, and damage to the organization's reputation.

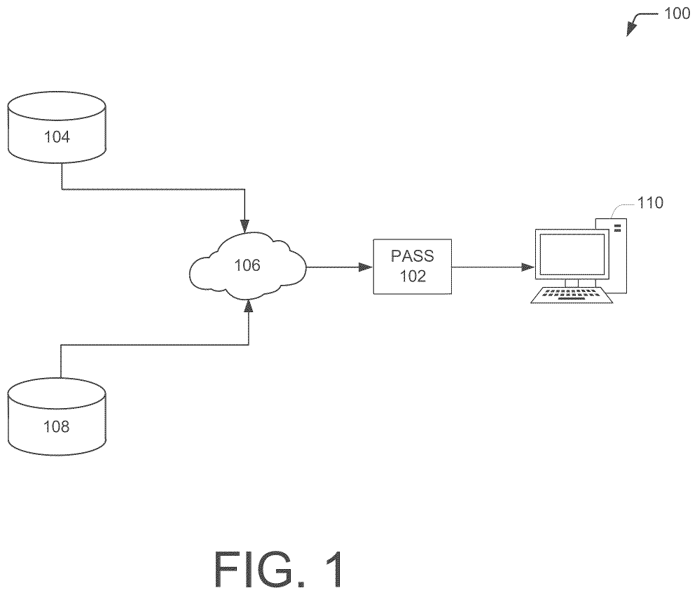

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment for facilitating simulation of audits corresponding to an industrial process within an industrial setup, in accordance with an example of the present subject matter. Examples of the industrial setup may include, but are not limited to, manufacturing plants, chemical processing facilities, pharmaceutical production units, food and beverage processing plants, automotive assembly lines, aerospace manufacturing facilities, semiconductor fabrication plants, oil refineries, power generation plants, water treatment facilities, textile mills, paper mills, steel mills, electronics assembly plants, biotechnology laboratories, and mining operations.

The environment 100 may include a Preventive Audit Simulation System (PASS) 102. In an example, the PASS 102 may perform simulation of audits corresponding to the industrial process, amongst other functions.

The environment 100 may further include an operations record database 104 coupled to the PASS 102. The operations record database 104 may be coupled to the PASS 102 either through a direct communication link, or through multiple communication links of a network 106. The network 106 may be a wireless or a wired network, or a combination thereof. The network 106 can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the communication network includes various network entities, such as gateways and routers; however, such details have been omitted to maintain the brevity of the description.

In an example, the operations record database 104 may store process documentation corresponding to a current operating state of the industrial process. The process documentation pertaining to the current operating state of an industrial process may encompass a comprehensive collection of records, reports, and supporting documentation that accurately reflect the real-time conditions, parameters, and performance of the industrial process and various equipment associated with the industrial process. The process documentation may facilitate verifying that the industrial process is operating within the intended specifications, facilitating efficient troubleshooting and ensuring adherence to regulatory standards and compliance requirements.

The operations record database 104 may further store surveillance data corresponding to at least one production floor within the industrial setup. In an example, the surveillance data may be obtained from an IoT setup installed within the industrial setup for monitoring the production floor. The surveillance data may include real-time equipment performance metrics, environmental conditions such as temperature and humidity, production line speeds, inventory levels, worker movement patterns, energy consumption data, quality control measurements, machine vibration data, noise levels, air quality parameters, process cycle times, material flow rates, equipment downtime logs, safety incident reports, and visual data from cameras monitoring critical areas of the production floor.

Further, the environment 100 may also include a benchmark database 108 coupled to the PASS 102. The benchmark database 108 may be coupled to the PASS 102 through the network 106.

In an example, the benchmark database 108 may store different thresholds corresponding to different operational parameters associated with different industrial processes. For instance, in an example, the benchmark database 108 may store auditor thresholds corresponding to different operational parameters. In the example, the auditor thresholds may be determined based on historical audit findings associated with at least one auditor. In another example, the benchmark database 108 may store historical thresholds corresponding to different operational parameters. In the example, the historical thresholds may be determined based on historical audit findings associated with at least one of the industrial setup, the industrial process, and at least a second industrial setup similar to the industrial setup. In yet another example, the benchmark database 108 may store standard thresholds corresponding to different operational parameters. In the example, the standard thresholds may be determined based on standard operating protocols associated with different industrial processes.

The environment 100 may further include a Human-Machine Interface (HMI) system 110 coupled to the PASS 102. In an example, the HMI system 110 may be utilized for receiving different inputs corresponding to industrial process and presenting results corresponding to the inputs to operators within the industrial setup.

In an example, the PASS 102 may obtain a plurality of operational parameters corresponding to the industrial process. The plurality of operational parameters may be indicative of a current operating state of the industrial process. In an example, the PASS 102 may obtain the plurality of operational parameters from the operations record database 104.

Thereafter, the PASS 102 may compare an operational parameter from the plurality of operational parameters with a corresponding auditor threshold. In an example, the PASS 102 may obtain the auditor threshold from the benchmark database 108. The PASS 102 may perform the comparison to identify a first deviation in the current operating state from an auditor operating protocol. The auditor operating protocol may represent a set of predefined standards, procedures, and expectations corresponding to an auditor to evaluate the compliance and performance of the industrial process. The auditor operating protocol may include specific criteria for assessing various aspects of the industrial process, such as quality control measures, safety protocols, documentation practices, equipment maintenance schedules, and adherence to regulatory requirements.

The PASS 102 may then generate a first audit finding based on the first deviation. The PASS 102 may then determine a first corrective action corresponding to the first deviation based on the first audit finding. Subsequently, the PASS 102 may recommend the first corrective action for mitigating the first deviation.

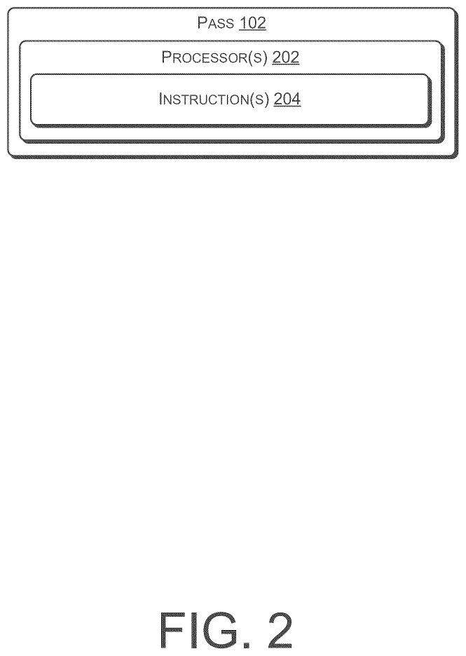

FIG. 2 illustrates a schematic of the PASS 102, in accordance with an example of the present subject matter. The PASS 102 may comprise a processor 202. The processor 202 may fetch and execute the computer-readable instructions 204 stored in a memory (not depicted in FIG. 2), to facilitate simulation of audits corresponding to the industrial process, amongst other functions.

In operation, the processor 202 may cause the PASS 102 to obtain the plurality of operational parameters corresponding to the industrial process. The plurality of operational parameters may be indicative of the current operating state of the industrial process.

Thereafter, the processor 202 may compare an operational parameter from the plurality of operational parameters with the corresponding auditor threshold. The processor 202 may perform the comparison to identify the first deviation in the current operating state from the auditor operating protocol.

The processor 202 may then generate the first audit finding based on the first deviation. Subsequently, the processor 202 may determine the first corrective action corresponding to the first deviation based on the first audit finding. The processor 202 may then cause the PASS 102 to recommend the first corrective action for mitigating the first deviation.

The manner in which the PASS 102 facilitates simulation of audits corresponding to the industrial process is further described in conjunction with the forthcoming figures.

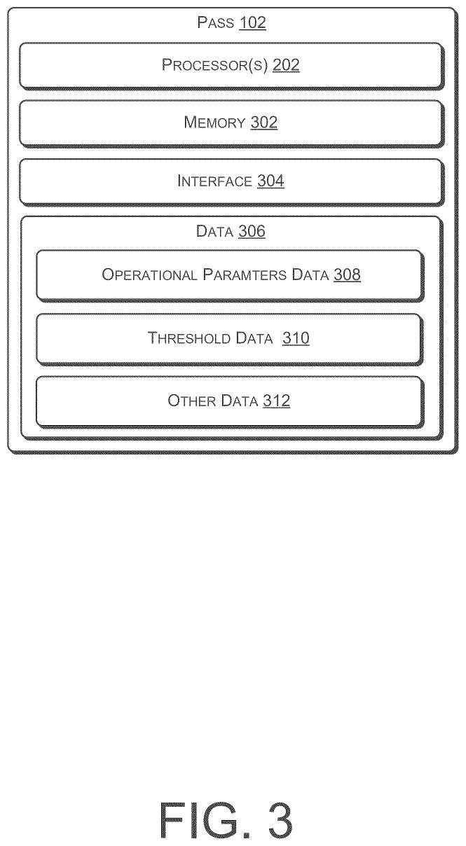

FIG. 3 illustrates the schematic of the PASS 102, in accordance with another example of the present subject matter.

The PASS 102 may comprise the processor 202, a memory 302, and an interface 304 coupled to the memory 302. The functions of various elements shown in the figs., including any functional blocks labelled as “processor”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly comprise, without limitation, digital signal processor (DSP) hardware, network processor, application specific integrated circuit (ASIC), field programmable gate array (FPGA). Other hardware, standard and/or custom, may also be coupled to the processor.

The memory 302 may be a computer-readable medium, examples of which comprise volatile memory (e.g., RAM), and/or non-volatile memory (e.g., Erasable Programmable read-only memory, i.e., EPROM, flash memory, etc.). The memory 302 may be an external memory, or internal memory, such as a flash drive, a compact disk drive, an external hard disk drive, or the like. The memory 302 may further comprise data which either may be utilized or generated during the operation of the PASS 102.

The interface 304 may allow the connection or coupling of the PASS 102 with one or more other devices, through a wired (e.g., Local Area Network, i.e., LAN) connection or through a wireless connection (e.g., Bluetooth®, WiFi). The interface 304 may also enable intercommunication between different logical as well as hardware components of the PASS 102.

The PASS 102 may further comprise data 306 that may be utilized or generated by the processor 202 while performing a variety of functions. In an example, the data 306 comprises operational parameters data 308, threshold data 310, and other data 312. The other data 312, amongst other things, may serve as a repository for storing data that is processed, received, or generated as a result of the execution of the instructions by the processor 202. In an example, the data 306 may be stored in the memory 302.

In operation, the processor 202 may cause the PASS 102 to obtain a plurality of operational parameters corresponding to the industrial process, where the plurality of operational parameters is indicative of a current operating state of the industrial process. In an example, to obtain the plurality of operational parameters, the processor 202 may cause the PASS 102 to retrieve the process documentation from the operations record database 104. The processor 202 may then cause the PASS 102 to extract the plurality of operational parameters from the process documentation. In another example, the processor 202 may cause the PASS 102 to retrieve the surveillance data from the operations record database 104. The processor 202 may then cause the PASS 102 to derive the plurality of operational parameters from the surveillance data. The processor 202 may then cause the PASS 102 to store the plurality of operational parameters in the operational parameters data 308.

The processor 202 may cause the PASS 102 to obtain the plurality of operational parameters upon receiving an audit simulation indication for performing an audit corresponding to the industrial process. In an example, the processor 202 may cause the PASS 102 to receive the audit simulation indication from the HMI system 110. Further, the audit simulation indication may include at least one of an audit type associated with the audit. In response to receiving the audit simulation indication, the processor 202 may determine an audit question corresponding to the audit type. In an example, the processor 202 may determine the audit question from a list of frequently asked questions generated based on at least one historical audit corresponding to the audit type. For instance, if the audit type is related to quality control, the processor 202 may determine an audit question such as “Are all quality control checkpoints properly documented and up to date?” or “Is there a system in place for tracking and addressing non-conformities?” If the audit type is related to safety protocols, the processor 202 may determine an audit question such as “Are all employees properly trained on current safety procedures?” or “Are emergency response plans regularly updated and tested?” The processor 202 may then use these audit questions to guide the selection and analysis of relevant operational parameters.

The processor 202 may cause the PASS 102 to obtain the plurality of operational parameters based on the audit question. For instance, if the audit question is “Are all quality control checkpoints properly documented and up to date?”, the processor 202 may cause the PASS 102 to retrieve operational parameters related to quality control documentation timestamps, frequency of updates, and completeness of records. If the question is “Is there a system in place for tracking and addressing non-conformities?”, the processor 202 may obtain parameters such as non-conformity incident logs, resolution timelines, and corrective action records. For safety-related questions like “Are all employees properly trained on current safety procedures?”, the processor 202 may gather operational parameters including employee training records, safety certification expiration dates, and attendance logs for safety briefings. In cases where the audit question concerns emergency preparedness, such as “Are emergency response plans regularly updated and tested?”, the processor 202 may retrieve parameters related to emergency drill frequencies, plan revision dates, and test result documentation.

In an example of the present subject matter, once the plurality of operational parameters is obtained, the processor 202 may compare at least one operational parameter from the plurality of operational parameters with at least one corresponding auditor threshold to determine a first deviation of the current operating state from the auditor operating protocol. The processor 202 may cause the PASS 102 to obtain the at least one auditor threshold from the benchmark database 108.

The processor 202 may then generate the first audit finding based on the first deviation. Audit findings may include details such as the specific parameter that deviated, the extent of the deviation, the time period during which the deviation occurred, and the potential impact on product quality or process safety. The processor 202 may categorize a severity of the audit finding based on predefined criteria, which may help prioritize corrective actions and resource allocation.

Subsequently, the processor 202 may determine the first corrective action corresponding to the first deviation based on the first audit finding. To determine the first corrective action, the processor 202 may analyse the first audit finding using a protocol adherence machine learning model, where the protocol adherence machine learning model is trained on a plurality of historical audit findings and corrective actions initiated to address the plurality of historical audit findings.

The processor 202 may then cause the PASS 102 to recommend the first corrective action for mitigating the first deviation. The processor 202 may cause the PASS 102 to recommend the first corrective action by generating a notification indicative of the first corrective action on the HMI system 110. In an example, the first corrective action may then be implemented for mitigating the first deviation.

In an example, once the first corrective action is implemented, the processor 202 may then compare the at least one operational parameter from the plurality of operational parameters with at least one corresponding historical threshold. In the example, the processor 202 may cause the PASS 102 to obtain the at least one corresponding historical threshold from the benchmark database 108.

The processor 202 may compare the at least one operational parameter with the at least one corresponding historical threshold to identify a second deviation in the current operating state from a historical operating protocol corresponding to the industrial process. The historical operating protocol may represent a set of established practices, procedures, and performance benchmarks that have been developed and refined over time based on past experiences, successful audits, and industry best practices specific to the industrial process. The historical operating protocol may include historically acceptable ranges for various operational parameters, documented procedures that have consistently met compliance standards, and performance metrics that have been associated with successful operations in the past. The historical operating protocol may serve as a baseline for comparing current operations against proven methodologies, facilitating identification of deviations that may not align with previously successful practices or established norms within the specific industrial context. The processor 202 may then generate a second audit finding based on the first deviation.

The processor 202 may then identify the second corrective action corresponding to the second deviation based on the second audit finding. To determine the second corrective action, the processor 202 may analyse the second audit finding using the protocol adherence machine learning model.

The processor 202 may then cause the PASS 102 to recommend the second corrective action for mitigating the second deviation. The processor 202 may cause the PASS 102 to recommend the second corrective action by generating a notification indicative of the second corrective action on the HMI system 110. In an example, the second corrective action may then be implemented for mitigating the second deviation.

It would be noted that the identifying and mitigating the deviation of the current operating state from the historical operating protocol, subsequent to identification and mitigation of deviation of the current operating state from the auditor operating protocol may enable compliance of the industrial process with a set of predefined standards, procedures, and expectations corresponding to an auditor while also ensuring compliance with well-established industrial norms.

In an example, once the first corrective action and the second corrective action are implemented, the processor 202 may then compare the at least one operational parameter from the plurality of operational parameters with at least one corresponding standard threshold. In the example, the processor 202 may cause the PASS 102 to obtain the at least one corresponding standard threshold from the benchmark database 108.

The processor 202 may compare the at least one operational parameter with the at least one corresponding standard threshold to identify a third deviation in the current operating state from a standard operating protocol corresponding to the industrial process. The standard operating protocol may represent a set of industry-wide or regulatory-defined guidelines, specifications, and best practices that establish the minimum acceptable standards for the industrial process. The standard operating protocol may encompass standardized procedures, safety requirements, quality control measures, and performance metrics that are widely recognized and adopted across the industry. The standard operating protocol may include specifications from regulatory bodies, international standards organizations, or industry associations that define the baseline expectations for process safety, product quality, environmental compliance, and operational efficiency. The standard operating protocol serves as a universal benchmark against which the current operating state can be evaluated, ensuring that the industrial process meets or exceeds the established norms and regulatory requirements of the industry.

The processor 202 may then generate a third audit finding based on the first deviation.

The processor 202 may then identify the third corrective action corresponding to the third deviation based on the third audit finding. To determine the third corrective action, the processor 202 may analyse the third audit finding using the protocol adherence machine learning model.

The processor 202 may then cause the PASS 102 to recommend the third corrective action for mitigating the third deviation. The processor 202 may cause the PASS 102 to recommend the third corrective action by generating a notification indicative of the third corrective action on the HMI system 110. In an example, the third corrective action may then be implemented for mitigating the second deviation.

It would be noted that the identifying and mitigating the deviations of the current operating state from the standard operating protocol, subsequent to identification and mitigation of deviation of the current operating state from the auditor operating protocol and the historical operating protocol, may enable compliance of the industrial process with the set of predefined standards, procedures, and expectations corresponding to an auditor while also ensuring compliance with well-established industrial norms and standards.

In another example of the present subject matter, once the plurality of operational parameters is obtained, the processor 202 may compare at least one operational parameter from the plurality of operational parameters with at least one corresponding threshold to determine a deviation of the current operating state from a first unified operating protocol. In an example, the processor 202 may cause the PASS 102 to obtain the at least one threshold from the benchmark database 108. In the example, the at least one corresponding threshold may be determined based on historical audit findings associated with at least one of an auditor, the industrial setup, the industrial process, and at least a second industrial setup similar to the industrial setup.

The first unified operating protocol may represent a comprehensive framework that integrates auditor-specific expectations, historical performance benchmarks, and industry-standard requirements into a single, cohesive set of operational guidelines. The first unified operating protocol may combine the stringent criteria derived from historical audit findings, the proven practices established through successful past operations, and the standardized requirements set by regulatory bodies and industry associations. By unifying these diverse elements, the first unified operating protocol may provide a holistic approach to operational compliance, addressing the nuanced preferences of auditors while ensuring adherence to both time-tested methodologies and current industry standards. The unified approach may enable the industrial process to simultaneously meet auditor expectations, maintain consistency with historical best practices, and comply with broader industry regulations, thereby offering a more robust and comprehensive basis for evaluating the current operating state.

The processor 202 may then generate an audit finding based on the deviation.

Subsequently, the processor 202 may determine at least one corrective action corresponding to the deviation based on the audit finding. To determine the corrective action, the processor 202 may analyse the audit finding using a protocol adherence machine learning model, where the protocol adherence machine learning model is trained on a plurality of historical audit findings and corrective actions initiated to address the plurality of historical audit findings.

The processor 202 may then cause the PASS 102 to recommend the at least one corrective action for mitigating the deviation. The processor 202 may cause the PASS 102 to recommend the at least one corrective action by generating a notification indicative of the at least one corrective action on the HMI system 110. In an example, the at least one corrective action may then be implemented for mitigating the deviation.

In an example, once the corrective action is implemented, the processor 202 may then compare the at least one operational parameter from the plurality of operational parameters with at least one corresponding standard threshold. In the example, the processor 202 may cause the PASS 102 to obtain the at least one corresponding standard threshold from the benchmark database 108.

The processor 202 may compare the at least one operational parameter with the at least one corresponding standard threshold to identify the fourth deviation in the current operating state from the standard operating protocol corresponding to the industrial process.

The processor 202 may then generate a fourth audit finding based on the fourth deviation.

The processor 202 may then identify the fourth corrective action corresponding to the fourth deviation based on the fourth audit finding. To determine the fourth corrective action, the processor 202 may analyse the fourth audit finding using the protocol adherence machine learning model.

The processor 202 may then cause the PASS 102 to recommend the fourth corrective action for mitigating the third deviation. The processor 202 may cause the PASS 102 to recommend the fourth corrective action by generating a notification indicative of the fourth corrective action on the HMI system 110. In an example, the fourth corrective action may then be implemented for mitigating the second deviation.

It would be noted that the identifying and mitigating the deviations of the current operating protocol from the standard operating protocol, subsequent to identification and mitigation of deviation of the current operating state from the first unified operating protocol, may enable compliance of the industrial process with the set of predefined standards, procedures, and expectations corresponding to an auditor while also ensuring compliance with well-established industrial norms and standards.

In yet another example of the present subject matter, once the plurality of operational parameters is obtained, the processor 202 may compare at least one operational parameter from the plurality of operational parameters with at least one corresponding threshold to determine a deviation of the current operating state from a second unified operating protocol. In an example, the processor 202 may cause the PASS 102 to obtain the at least one threshold from the benchmark database 108. In the example, the at least one corresponding threshold may be determined based on the standard operating protocol corresponding to the industrial process and historical audit findings associated with at least one of an auditor, the industrial setup, the industrial process, and at least a second industrial setup similar to the industrial setup.

The second unified operating protocol may represent an integrated operational framework that synthesizes standard industry practices, historical performance data, auditor-specific criteria, and current regulatory requirements into a comprehensive set of guidelines. The second unified operating protocol may combine the rigorous standards established by regulatory bodies and industry associations with the nuanced expectations derived from auditor preferences and historical audit findings. The second unified operating protocol may also incorporate lessons learned from past operational successes and failures within the specific industrial setup and similar setups. By merging these diverse elements, the second unified operating protocol may offer a more adaptive and context-specific approach to operational compliance, allowing for flexibility in addressing industry-wide standards while accommodating the unique aspects of the particular industrial process and its historical performance. The second unified operating protocol unified approach may enable a more nuanced evaluation of the current operating state, considering both standardized benchmarks and the specific operational context of the industrial setup. The processor 202 may then generate an audit finding based on the deviation.

Subsequently, the processor 202 may determine at least one corrective action corresponding to the deviation based on the audit finding. To determine the corrective action, the processor 202 may analyse the audit finding using a protocol adherence machine learning model, where the protocol adherence machine learning model is trained on a plurality of historical audit findings and corrective actions initiated to address the plurality of historical audit findings.

The processor 202 may then cause the PASS 102 to recommend the at least one corrective action for mitigating the deviation. The processor 202 may cause the PASS 102 to recommend the at least one corrective action by generating a notification indicative of the at least one corrective action on the HMI system 110. In an example, the at least one corrective action may then be implemented for mitigating the deviation.

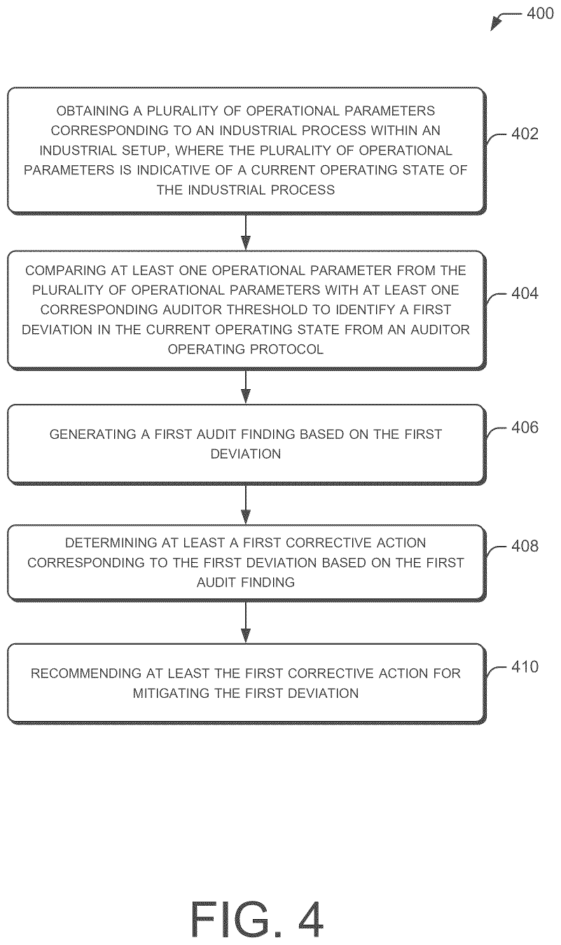

FIGS. 4, 5, 6, 7, 8, 9, and 10 illustrate methods for facilitating simulation of audits corresponding to an industrial process, in accordance with examples of the present subject matter. The order in which the method steps are described is not intended to be construed as a limitation, and any number of the described method blocks may be combined in any order to implement the methods, or an alternative method. Further, the methods 400, 500, 600, 700, 800, 900, and 1000 may be implemented by processing resource or computing device(s) through any suitable hardware, non-transitory machine-readable instructions, or combination thereof.

It may also be understood that methods 400, 500, 600, 700, 400, 500, 600, 700, 800, 900, and 1000 may be performed by programmed computing devices, such as the PASS 102. Furthermore, the methods 400, 500, 600, 700, 800, 900, and 1000 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 400, 500, 600, 700, 800, 900, and 1000 are described below with reference to the PASS 102, as described above; other suitable systems for the execution of these methods may also be utilized. Additionally, implementation of the method is not limited to such examples.

As already mentioned, FIG. 4 illustrates a method for facilitating simulation of audits corresponding to the industrial process, in accordance with an example of the present subject matter.

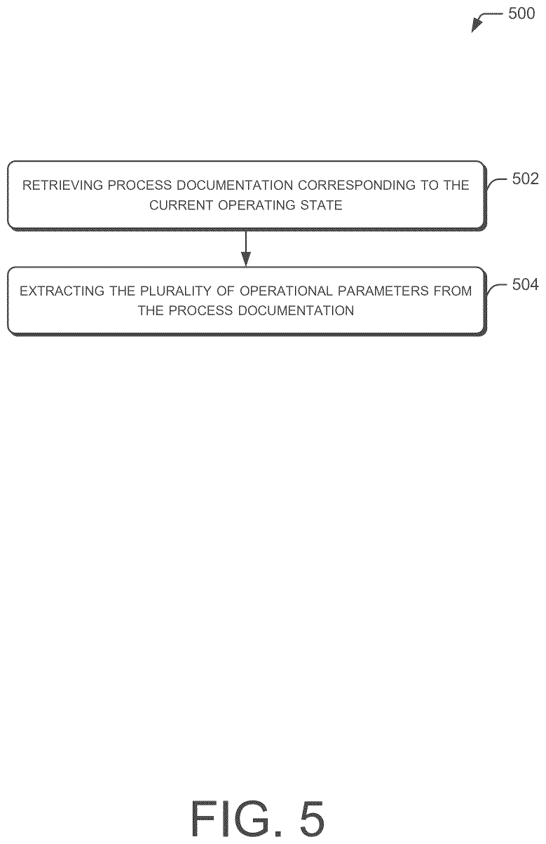

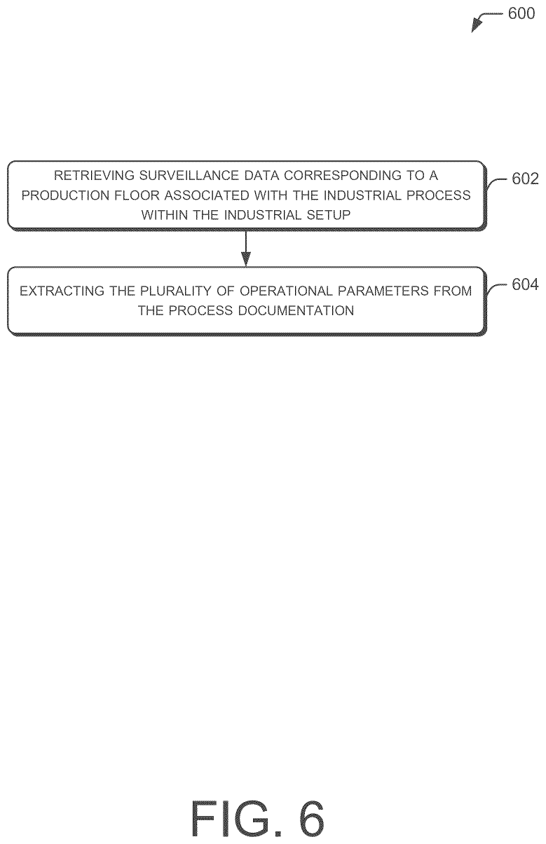

At block 402, a plurality of operational parameters corresponding to an industrial process within an industrial setup is obtained, where the plurality of operational parameters is indicative of a current operating state of the industrial process. The manner in which the plurality of operational parameters may be obtained is described in conjunction with FIGS. 5 and 6.

At block 404, at least one operational parameter from the plurality of operational parameters is compared with at least one corresponding auditor threshold to identify a first deviation in the current operating state from an auditor operating protocol. In an example, the at least one corresponding auditor threshold is determined based on historical audit findings associated with at least one auditor.

At block 406, a first audit finding may be generated based on the first deviation.

At block 408, at least a first corrective action corresponding to the first deviation may be determined. In an example, the first correction action may be determined based on the first audit finding. In the example, the first correction action may be determined by analysing the first audit finding using a protocol adherence machine learning model, where the protocol adherence machine learning model is trained on a plurality of historical audit findings and corrective actions initiated to address the plurality of historical audit findings.

At block 410, at least the first corrective action may be recommended for mitigating the first deviation. In an example, the first corrective action may then be implemented to mitigate the first deviation.

FIG. 5 illustrates a method for obtaining the plurality of operating parameters corresponding to the industrial process, in accordance with an example of the present subject matter.

At block 502, process documentation corresponding to a current operating state of the industrial process is retrieved. The process documentation pertaining to the current operating state of an industrial process may encompass a comprehensive collection of records, reports, and supporting documentation that accurately reflect the real-time conditions, parameters, and performance of the industrial process and various equipment associated with the industrial process. The process documentation may facilitate verifying that the industrial process is operating within the intended specifications, facilitating efficient troubleshooting and ensuring adherence to regulatory standards and compliance requirements.

At block 504, the plurality of operational parameters is extracted from the process documentation.

FIG. 6 illustrates a method for obtaining a plurality of operational parameters corresponding to the industrial process, in accordance with another example of the present subject matter.

At block 602, surveillance data corresponding to a production floor associated with the industrial process within an industrial setup is retrieved. The surveillance data may include real-time equipment performance metrics, environmental conditions such as temperature and humidity, production line speeds, inventory levels, worker movement patterns, energy consumption data, quality control measurements, machine vibration data, noise levels, air quality parameters, process cycle times, material flow rates, equipment downtime logs, safety incident reports, and visual data from cameras monitoring critical areas of the production floor.

At block 604, the plurality of operational parameters is extracted from the surveillance data.

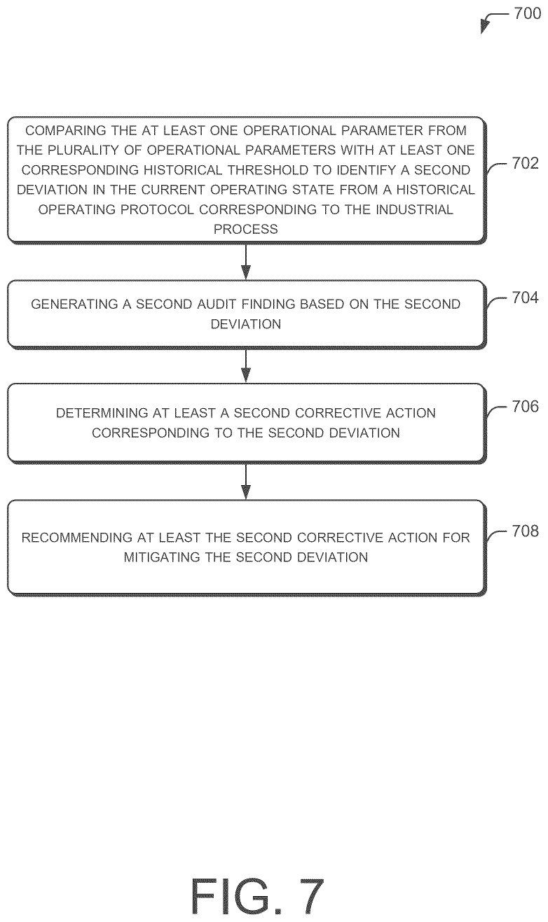

FIG. 7 illustrates a method for facilitating simulation of audits corresponding to the industrial process, in accordance with another example of the present subject matter. In an example, the method 700 may be performed subsequent to implementation of at least the first corrective action for mitigating the first deviation.

At block 702, the at least one operational parameter from a plurality of operational parameters is compared with at least one corresponding historical threshold to identify a second deviation in a current operating state from a historical operating protocol corresponding to the industrial process. The at least one corresponding historical threshold is determined based on historical audit findings associated with at least one of the industrial setup, the industrial process, and at least a second industrial setup similar to the industrial setup.

At block 704, a second audit finding is generated based on the second deviation.

At block 706, at least a second corrective action corresponding to the second deviation is determined. In an example, at least the second corrective action is determined by analysing the second audit finding using the protocol adherence machine learning model.

At block 708, at least the second corrective action is recommended for mitigating the second deviation. In an example, the second corrective action may then be implemented to mitigate the second deviation.

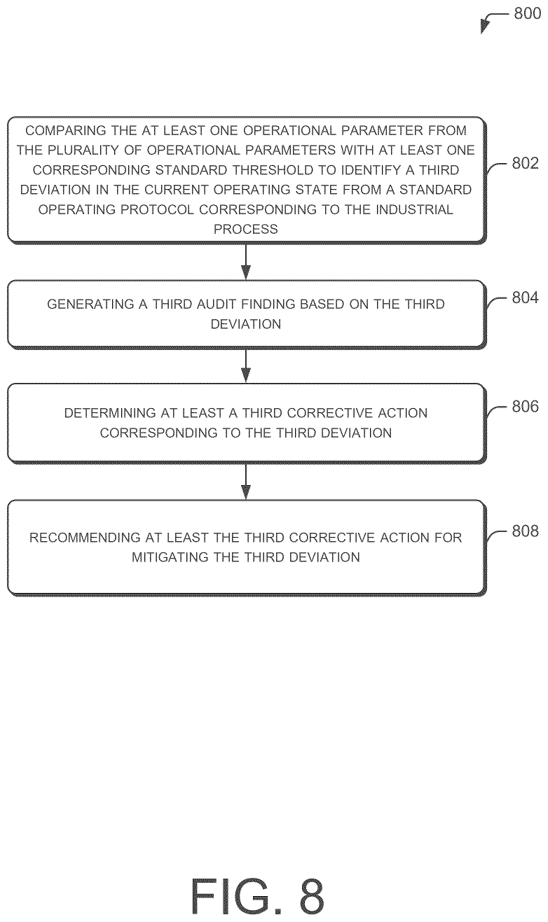

FIG. 8 illustrates a method for facilitating simulation of audits corresponding to the industrial process, in accordance with yet another example of the present subject matter. In an example, the method 800 may be performed subsequent to implementation of at least the second corrective action for mitigating the second deviation.

At block 802, at least one operational parameter from a plurality of operational parameters is compared with at least one corresponding standard threshold to identify a third deviation in a current operating state from a standard operating protocol corresponding to the industrial process. The at least one corresponding standard threshold is determined based on the standard operating protocol.

At block 804, a third audit finding is generated based on the third deviation.

At block 806, at least a third corrective action corresponding to the third deviation is determined. In an example, at least the third corrective action is determined by analysing the third audit finding using the protocol adherence machine learning model.

At block 808, at least the third corrective action is recommended for mitigating the third deviation.

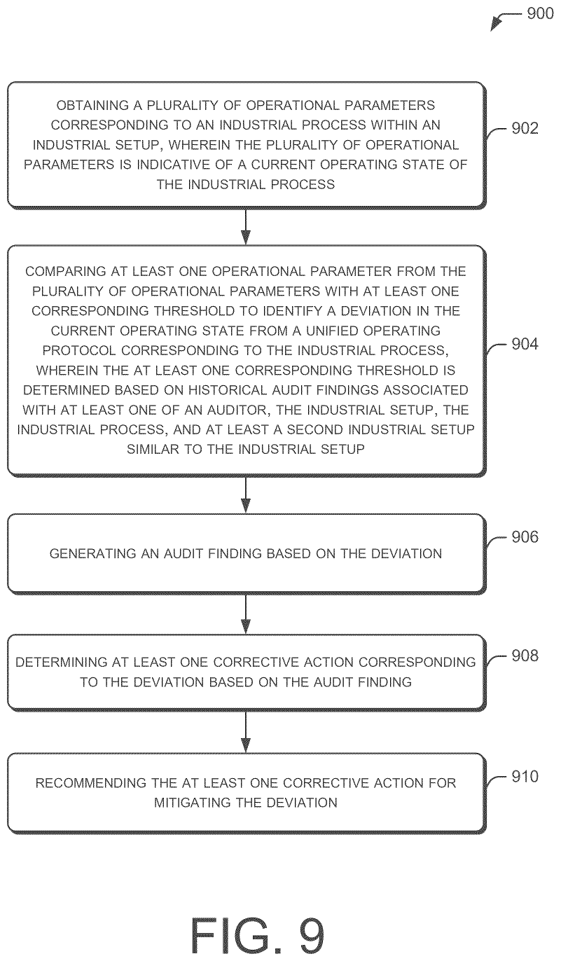

FIG. 9 illustrates a method for facilitating simulation of audits corresponding to the industrial process, in accordance with yet another example of the present subject matter.

At block 902, a plurality of operational parameters corresponding to an industrial process within an industrial setup is obtained, where the plurality of operational parameters is indicative of a current operating state of the industrial process. The manner in which the plurality of operational parameters may be obtained is described in conjunction with FIGS. 5 and 6.

At block 904, at least one operational parameter from the plurality of operational parameters is compared with at least one corresponding threshold to identify a deviation in the current operating state from a unified operating protocol corresponding to the industrial process. In an example, the unified operating protocol may correspond to the first unified operating protocol. The at least one corresponding threshold is determined based on historical audit findings associated with at least one of an auditor, the industrial setup, the industrial process, and at least a second industrial setup similar to the industrial setup.

At block 906, an audit finding is generated based on the deviation.

At block 908, at least one corrective action corresponding to the deviation is determined based on the audit finding. In an example, the at least one corrective action is determined by analysing the audit finding using the protocol adherence machine learning model.

At block 910, the at least one corrective action is recommended for mitigating the deviation.

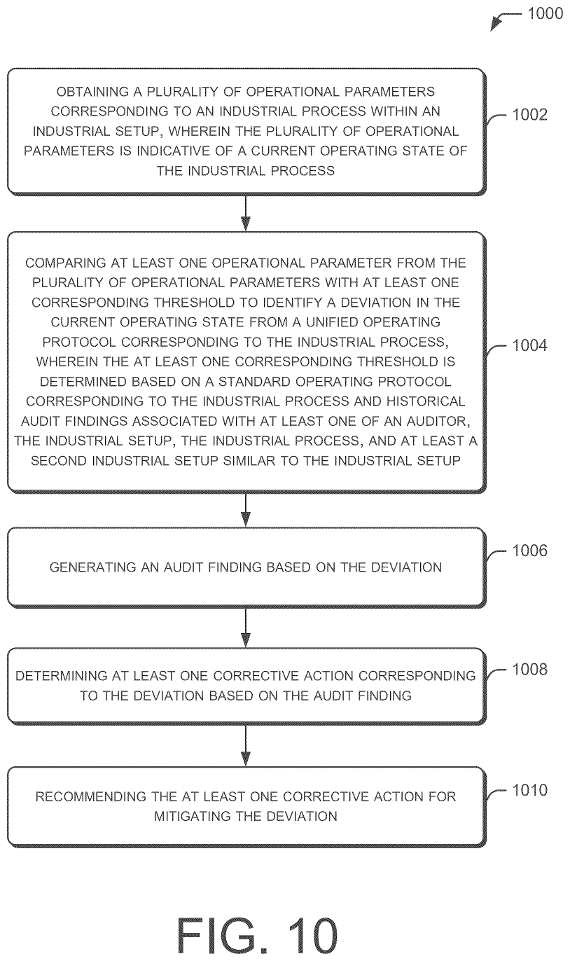

FIG. 10 illustrates a method for facilitating simulation of audits corresponding to the industrial process, in accordance with yet another example of the present subject matter.

At block 1002, a plurality of operational parameters corresponding to an industrial process within an industrial setup is obtained, where the plurality of operational parameters is indicative of a current operating state of the industrial process. The manner in which the plurality of operational parameters may be obtained is described in conjunction with FIGS. 5 and 6.

At block 1004, at least one operational parameter from the plurality of operational parameters is compared with at least one corresponding threshold to identify a deviation in the current operating state from a unified operating protocol corresponding to the industrial process. In an example, the unified operating protocol may correspond to the second unified operating protocol. The at least one corresponding threshold is determined based on a standard operating protocol corresponding to the industrial process and historical audit findings associated with at least one of an auditor, the industrial setup, the industrial process, and at least a second industrial setup similar to the industrial setup.

At block 1006, an audit finding is generated based on the deviation.

At block 1008, at least one corrective action corresponding to the deviation is determined based on the audit finding. In an example, the at least one corrective action is determined by analysing the audit finding using the protocol adherence machine learning model.

At block 1010, the at least one corrective action is recommended for mitigating the deviation.

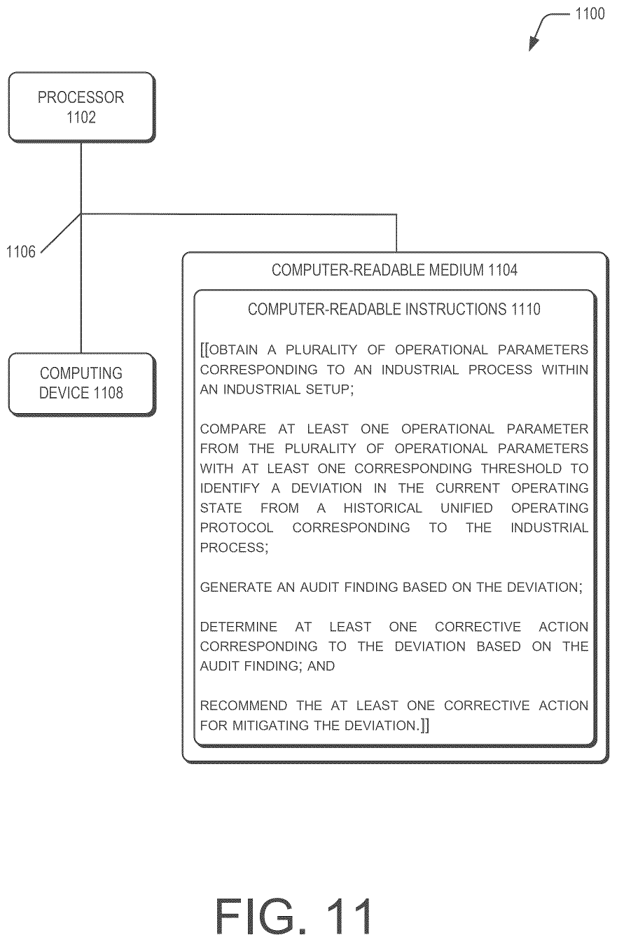

FIG. 11 illustrates a non-transitory computer-readable medium for facilitating simulation of audits corresponding to an industrial process, in accordance with examples of the present subject matter.

In an example, the computing environment 1100 includes processor 1102 communicatively coupled to a non-transitory computer readable medium 1104 through communication link 1106. In an example implementation, the computing environment 1100 may be for example, the PASS 102. In an example, the processor 1102 may have one or more processing resources for fetching and executing computer-readable instructions from the non-transitory computer readable medium 1104. The processor 1102 and the non-transitory computer readable medium 1104 may be implemented, for example, in the PASS 102.

The non-transitory computer readable medium 1104 may be, for example, an internal memory device or an external memory. In an example implementation, the communication link 1106 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1104 includes a set of computer readable instructions 1110 which may be accessed by the processor 1102 through the communication link 1106 and subsequently executed for facilitating management of product recall drives. The processor(s) 1102 and the non-transitory computer readable medium 1104 may also be communicatively coupled to a computing device 1108 over the network.

Referring to FIG. 11, in an example, the non-transitory computer readable medium 1104 includes computer readable instructions 1110 that cause the processor 1102 to obtain a plurality of operational parameters corresponding to an industrial process within an industrial setup, where the plurality of operational parameters is indicative of a current operating state of the industrial process. In an example, to obtain the plurality of operational parameters, the instructions 1110 may cause the processor 1102 to retrieve process documentation corresponding to the current operating state. The instructions 1110 may then cause the processor 1102 to extract the plurality of operational parameters from the process documentation. In another example, to obtain the plurality of operational parameters, the instructions 1110 may cause the processor 1102 to retrieve surveillance data corresponding to a production floor associated with the industrial process within the industrial setup. The instructions 1110 may then cause the processor 1102 to extract the plurality of operational parameters from the surveillance data.

The instructions 1110 may further cause the processor 1102 to compare at least one operational parameter from the plurality of operational parameters with at least one corresponding threshold to identify a deviation in the current operating state from a unified operating protocol corresponding to the industrial process. In an example, the unified operating protocol may correspond to the second unified operating protocol. In the example, the at least one corresponding threshold is determined based on a standard operating protocol corresponding to the industrial process and historical audit findings associated with at least one of an auditor, the industrial setup, the industrial process, and at least a second industrial setup similar to the industrial setup.

The instructions 1110 may then cause the processor 1102 to generate an audit finding based on the deviation.

Subsequently, the instructions 1110 may cause the processor 1102 to determine at least one corrective action corresponding to the deviation based on the audit finding. In an example, to determine the at least one corrective action, the instructions 1110 may cause the processor 1102 to analyse the audit finding using a protocol adherence machine learning model, where the protocol adherence machine learning model is trained on a plurality of historical audit findings and corrective actions initiated to address the plurality of historical audit findings.

The instructions 1110 may then cause the processor 1102 to recommend the at least one corrective action for mitigating the deviation.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method implemented by a Preventive Audit Simulation System (PASS), the method comprising:
obtaining, from an operations record database coupled to the PASS, a plurality of operational parameters corresponding to an industrial process within an industrial setup, wherein the plurality of operational parameters is indicative of a current operating state of the industrial process;
comparing, by the PASS, at least one operational parameter from the plurality of operational parameters with at least one corresponding auditor threshold to identify a first deviation in the current operating state from an auditor operating protocol, wherein the at least one corresponding auditor threshold is obtained from a benchmark database coupled to the PASS, and wherein the at least one corresponding auditor threshold is determined based on historical audit findings associated with at least one auditor;
generating, by the PASS, a first audit finding based on the first deviation;
determining, by the PASS, at least a first corrective action corresponding to the first deviation based on the first audit finding; and
recommending, by the PASS, at least the first corrective action for mitigating the first deviation.

2. The method of claim 1, wherein obtaining the plurality of operational parameters comprises:
retrieving, from the operations record database, process documentation corresponding to the current operating state; and
extracting, by the PASS, the plurality of operational parameters from the process documentation.

3. The method of claim 1, wherein obtaining the plurality of operational parameters comprises:
retrieving, from the operations record database, surveillance data corresponding to a production floor associated with the industrial process within the industrial setup; and
extracting, by the PASS, the plurality of operational parameters from the surveillance data.

4. The method of claim 1, wherein the plurality of operational parameters is obtained upon receiving an audit simulation indication for performing an audit corresponding to the industrial process, wherein the audit simulation indication comprises an audit type associated with the audit.

5. The method of claim 4, further comprising:
determining, by the PASS, an audit question corresponding to the audit type in response to the audit simulation indication, wherein the audit question is determined from a list of frequently asked questions generated based on at least one historical audit corresponding to the audit type; and
obtaining, by the PASS, the plurality of operational parameters based on the audit question.

6. The method of claim 1, further comprising:
comparing, by the PASS, the at least one operational parameter from the plurality of operational parameters with at least one corresponding historical threshold to identify a second deviation in the current operating state from a historical operating protocol corresponding to the industrial process, wherein the at least one corresponding historical threshold is obtained from the benchmark database, and wherein the at least one corresponding historical threshold is determined based on historical audit findings associated with at least one of the industrial setup, the industrial process, and at least a second industrial setup similar to the industrial setup;
generating, by the PASS, a second audit finding based on the second deviation;
determining, by the PASS, at least a second corrective action corresponding to the second deviation; and
recommending, by the PASS, at least the second corrective action for mitigating the second deviation.

7. The method of claim 6, further comprising:
comparing, by the PASS, the at least one operational parameter from the plurality of operational parameters with at least one corresponding standard threshold to identify a third deviation in the current operating state from a standard operating protocol corresponding to the industrial process, wherein the at least one corresponding standard threshold is obtained from the benchmark database, and wherein the at least one corresponding standard threshold is determined based on the standard operating protocol;
generating, by the PASS, a third audit finding based on the third deviation;
determining, by the PASS, at least a third corrective action corresponding to the third deviation; and
recommending, by the PASS, at least the third corrective action for mitigating the third deviation.

8. The method of claim 7, wherein determining at least the first corrective action comprises analysing the first audit finding using a protocol adherence machine learning model, wherein the protocol adherence machine learning model is trained on a plurality of historical audit findings and corrective actions initiated to address the plurality of historical audit findings.

9. The method of claim 1, further comprising generating, by the PASS, a notification indicative of the first corrective action on a Human Machine Interface (HMI) system within the industrial setup.

10. A Preventive Audit Simulation System (PASS) comprising:
at least one processor; and
a memory storing instructions that are executable by the at least one processor to:
obtain a plurality of operational parameters corresponding to an industrial process within an industrial setup, wherein the plurality of operational parameters is indicative of a current operating state of the industrial process;
compare at least one operational parameter from the plurality of operational parameters with at least one corresponding threshold to identify a deviation in the current operating state from a unified operating protocol corresponding to the industrial process, wherein the at least one corresponding threshold is determined based on historical audit findings associated with at least one of an auditor, the industrial setup, the industrial process, and at least a second industrial setup similar to the industrial setup;
generate an audit finding based on the deviation;
determine at least one corrective action corresponding to the deviation based on the audit finding; and
recommend the at least one corrective action for mitigating the deviation.

11. The PASS of claim 10, wherein to obtain the plurality of operational parameters, the processor is to:
retrieve process documentation corresponding to the current operating state; and
extract the plurality of operational parameters from the process documentation.

12. The PASS of claim 10, wherein to obtain the plurality of operational parameters, the processor is to:
retrieve surveillance data corresponding to a production floor associated with the industrial process within the industrial setup; and
extract the plurality of operational parameters from the surveillance data.

13. The PASS of claim 10, wherein the processor is to obtain the plurality of operating parameters upon receiving an audit simulation indication for performing an audit corresponding to the industrial process, wherein the audit simulation indication comprises at least one of an audit type associated with the audit.

14. The PASS of claim 13, wherein the processor is to:
determine an audit question corresponding to the audit type in response to the audit simulation indication, wherein the audit question is determined from a list of frequently asked questions generated based on at least one historical audit corresponding to the audit type; and
obtain the plurality of operational parameters based on the audit question.

15. The PASS of claim 10, wherein the processor further is to:
compare the at least one operational parameter from the plurality of operational parameters with at least one corresponding standard threshold to identify a fourth deviation in the current operating state from a standard operating protocol corresponding to the industrial process, wherein the at least one corresponding standard threshold is determined based on the standard operating protocol;
generate a fourth audit finding based on the fourth deviation;
determine at least a fourth corrective action corresponding to the fourth deviation; and
recommend the at least the fourth corrective action for mitigating the third deviation.

16. The PASS of claim 15, wherein to determine the at least one corrective action, the processor is to analyse the audit finding using a protocol adherence machine learning model, wherein the protocol adherence machine learning model is trained on a plurality of historical audit findings and corrective actions initiated to address the plurality of historical audit findings.

17. A non-transitory computer-readable medium comprising instructions that, when executed by at least one processor, cause the at least one processor to perform operations comprising:
obtain a plurality of operational parameters corresponding to an industrial process within an industrial setup, wherein the plurality of operational parameters is indicative of a current operating state of the industrial process;
compare at least one operational parameter from the plurality of operational parameters with at least one corresponding threshold to identify a deviation in the current operating state from a unified operating protocol corresponding to the industrial process, wherein the at least one corresponding threshold is determined based on a standard operating protocol corresponding to the industrial process and historical audit findings associated with at least one of an auditor, the industrial setup, the industrial process, and at least a second industrial setup similar to the industrial setup;
generate an audit finding based on the deviation;
determine at least one corrective action corresponding to the deviation based on the audit finding; and
recommend the at least one corrective action for mitigating the deviation.

18. The non-transitory computer readable medium of claim 17, wherein to obtain the plurality of operational parameters, the instructions cause the processor to:
retrieve process documentation corresponding to the current operating state; and
extract the plurality of operational parameters from the process documentation.

19. The non-transitory computer readable medium of claim 17, wherein to obtain the plurality of operational parameters, the instructions cause the processor to:
retrieve surveillance data corresponding to a production floor associated with the industrial process within the industrial setup; and
extract the plurality of operational parameters from the surveillance data.

20. The non-transitory computer readable medium of claim 17, wherein to determine the at least one corrective action, the instructions cause the processor to analyse the audit finding using a protocol adherence machine learning model, wherein the protocol adherence machine learning model is trained on a plurality of historical audit findings and corrective actions initiated to address the plurality of historical audit findings.
